(19) United States
(12) Patent Application Publication
(10) Pub. No.: US 2003/0019858 A1
(43) Pub. Date: Jan. 30, 2003

(54) Ceramic heater with thermal pipe for improving temperature uniformity, efficiency and robustness and manufacturing method

(75) Inventors: Charles N. Dornfest, Fremont, CA (US); Harold H. Mortensen, Carlsbad, CA (US); Richard J. Palicka, San Clemente, CA (US)

Correspondence Address: APPLIED MATERIALS, INC., 2881 SCOTT BLVD. M/S 2061, SANTA CLARA, CA, 95050, US

(73) Assignee: APPLIED MATERIALS, INC.

(21) Appl. No.: 09/921,369

(22) Filed: Jul. 27, 2001

(51) Int. Cl. B23K 10/00

(52) U.S. Cl. 219/158; 219/121.43; 118/725

(57) ABSTRACT

A ceramic heater for heating a substrate in a semiconductor manufacturing apparatus is disclosed. The ceramic heater, which contains a thermal heat pipe made from Graphfoil embedded in, e.g., AIN, permits <1° C. temperature difference from the center to the edge of a substrate in a substrate holder.

### BACKGROUND OF THE INVENTION

1. Field of the Invention

The present invention relates to an apparatus and method for forming films. In particular, the present invention relates to substrate heating equipment for heating a substrate during a semiconductor manufacturing process.

2. Background of the Art

The present invention relates to semiconductor processing. More specifically, the invention relates to methods and apparatus for forming films such as silicon oxide, tungsten, titanium, titanium nitride and titanium disilicide at temperatures of up to about 625° C. or greater. Such films may be used as patterned conductive layers, plugs between conductive layers, diffusion barrier layers, adhesion layers, and as a precursor layer to silicide formation. In addition, the present invention may be used, for example, in the deposition of other types of metal films, to alloy substrate materials, and to anneal substrate materials.

Films such as above have two main purposes: (1) to maintain charge storage, and (2) to maintain the largest amount of charge in the smallest amount of space. Thus, the thickness of such films needs to be controlled exactly. Controlling the thickness of a film during semiconductor processing is highly reliable on maintaining a constant temperature.

One of the primary steps in fabricating modern semiconductor devices is forming various layers, including dielectric layers and metal layers, on a semiconductor substrate. As is well known, these layers can be deposited by chemical vapor deposition (CVD) or physical vapor deposition (PVD). In a conventional thermal CVD process, reactive gases are supplied to the substrate surface where heat-induced chemical reactions (homogeneous or heterogeneous) take place to produce a desired film. The substrate is held on a substrate holder that is connected to a heating mechanism so as to indirectly heat the substrate.

In a conventional plasma CVD process, a controlled plasma is formed to decompose and/or energize reactive species to produce the desired film. In general, reaction rates in thermal and plasma processes may be controlled by controlling one or more of the following: temperature, pressure, plasma density, reactant gas flow rate, power frequency, power levels, chamber physical geometry, and others.

In an exemplary PVD system, a target (a plate of the material (substrate) that is to be deposited) is connected to a negative voltage supply (direct current (DC) or radio frequency (RF)) while a substrate holder facing the target is either grounded, floating, biased, heated, cooled, or some combination thereof. A gas, such as argon, is introduced into the PVD system, typically maintained at a pressure between a few millitorr (mtorr) and about 100 mtorr, to provide a medium in which a glow discharge can be initiated and maintained. When the glow discharge is started, positive ions strike the target, and target atoms are removed by momentum transfer. These target atoms subsequently condense into a thin film on the substrate, which is on the substrate holder.

Semiconductor device geometries have dramatically decreased in size since such devices were first introduced several decades ago. Since then, integrated circuits have generally followed the two-year/half-size rule (often called “Moore's Law”) which means that the number of devices which will fit on a chip doubles every two years. Today's substrate fabrication plants are routinely producing 0.5 μm and even 0.35 μm feature size devices, and tomorrow's plants soon will be producing devices having even smaller feature sizes. As device feature sizes become smaller and integration density increases (i.e., increased computational processing per unit volume or per unit area), issues not previously considered crucial by the industry are becoming of greater concern. For example, devices with increasingly high integration density have features with high aspect ratios (for example, about 6:1 or greater for 0.35 μm feature size devices). (Aspect ratio is defined as the height-to-spacing ratio of two adjacent steps.) High aspect ratio features, such as gaps, need to be adequately filled with a deposited layer in many applications.

Thus, increasingly stringent requirements for fabricating these high integration devices are needed and conventional substrate processing systems are becoming inadequate to meet these requirements. Additionally, as device designs evolve, more advanced capabilities are required in substrate processing systems used to deposit films made of materials needed to implement these devices.

A plasma-enhanced chemical vapor deposition (PECVD) system, at times, will be more suitable for forming film on substrates with high aspect ratio gaps. As is well known, a plasma, which is a mixture of ions and gas molecules, may be formed by applying energy, such as RF energy, to a process gas in the deposition chamber under the appropriate conditions, for example, chamber pressure, temperature, RF power, and others. The plasma reaches a threshold density to form a self-sustaining condition, known as forming a glow discharge (often referred to as “striking” or “igniting” the plasma). This RF energy raises the energy state of molecules in the process gas and forms ionic species from the molecules. Both the energized molecules and ionic species are typically more reactive than the process gas, and hence more likely to form the desired film. Advantageously, the plasma also enhances the mobility of reactive species across the surface of the substrate as the film forms, and results in films exhibiting good gap filling capability.

A susceptor (sometimes called a chuck and referred to throughout this description as “substrate holder”) is a mechanical part that holds the substrate in the deposition chamber. In addition, the substrate holder may act as an electrode, such as a DC or RF electrode. Conventional substrate holders may be formed of aluminum with an anodized surface layer. Unfortunately, these anodized aluminum substrate holders react with gases used for cleaning such as fluorine and the anodized layer flakes off. As the anodized layer flakes off, the properties of the deposited film, such as stress, uniformity, and particle count, drift until out of specification. The substrate holder must then be replaced. The typical lifetime of an anodized aluminum substrate holder is two to four thousand processing runs, so the anodized aluminum substrate holder needs to be replaced every one or two months.

Chemical species, such as chlorine, used in dry clean processes also attack the aluminum heaters. At temperatures higher than about 480° C., these chemical species may more aggressively attack and corrode aluminum heaters than at lower temperatures, thereby reducing the operational lifetime of the heater and undesirably requiring more frequent heater replacement. Heater replacement is expensive not only because of the cost of the heater, but also because the productive use of the deposition chamber is lost for the time the heater is being replaced. During such dry clean processes, a dummy substrate is often loaded onto the aluminum heater to try to minimize the attack on the heater. However, loading and unloading of the dummy substrates consumes time and decreases substrate throughput, i.e., the number of substrates processed per unit time. Also, some dummy substrates, which get attacked by the dry clean chemistries, are expensive and may need periodic replacement, which adds to the overall maintenance costs.

Furthermore, conventional PECVD systems (as well as conventional CVD and PVD systems) which use aluminum substrate holders as heaters experience limitations when used for certain processes, such as forming a titanium film from a vapor of, for example, titanium tetrachloride (TiCl₄). Aluminum corrosion, temperature limitations, unwanted deposition, and manufacturing efficiency are some of the problems with such conventional PECVD systems that may be used to deposit a film such as titanium. In the exemplary process, TiCl₄, which is a liquid at room temperature, and a carrier gas, such as helium, bubbled through this liquid generates vapor that can be carried to a deposition chamber. Such a titanium PECVD process may require a substrate temperature of about 600° C. to achieve a deposition rate of about 100 Å/min., which may be insufficient to achieve good substrate throughput. However, when the TiCl₄ disassociates to form the titanium film, chlorine is released into the chamber. In particular, the plasma, which enhances the titanium film deposition, forms chlorine atoms and ions that, as discussed above, undesirably tend to corrode aluminum heaters. The aluminum corrosion may also lead to processing degradation issues relating to metal contamination in the devices. Additionally, use of a PECVD system having an aluminum heater is limited to operation at temperatures less than about 480° C., which may therefore limit the film deposition rates that can be achieved. Aluminum is an inappropriate material for heaters operating at high temperature, because at temperatures greater than about 480° C., aluminum heaters experience softening, possibly resulting in warpage of and/or damage to the heater. Additional problems arise when aluminum heaters are used above about 480° C. in the presence of a plasma. In such an environment, the aluminum may backsputter, contaminating the substrate and chamber components. Furthermore, aluminum heaters, which tend to be incompatible even at lower temperatures with some of the chemical species associated with some deposition processes (such as the chlorine compounds produced in a titanium deposition process), experience greatly increased attack at higher temperatures.

Ceramic heaters have been proposed as an alternative to using aluminum heaters for deposition systems operating at or above about 400° C. Such ceramic heaters advantageously may be used in the presence of plasma and corrosive plasma species, such as chlorine-containing species found in titanium PECVD process and associated cleaning processes. Ceramic heaters typically have an electric heating element within a ceramic heater body, made of materials such as alumina (Al₂O₃) or aluminum nitride (AlN), which protects the heating element from the corrosive environment of the deposition chamber while transmitting heat from the heating element to the substrate.

However, using such ceramic heaters in deposition processes has introduced several challenges. Being somewhat brittle, ceramic may crack from thermal shock if repeatedly subjected to a sufficient thermal gradient.

U.S. Pat. Nos. 5,680,013 and 5,959,409 disclose ceramic protection material that includes a thin cover material fitted closely to heated metal. The patent discloses that the material can be used to protect the surfaces of gas distribution apparatus in plasma processing chambers.

U.S. Pat. No. 5,968,379 discloses a ceramic heater assembly with an integrated RF plane for bottom powered RF capability that allows PECVD deposition at a temperature of at least 400° C.

U.S. Pat. No. 5,855,687 discloses a substrate holder that has an outer diameter that is greater than the outer diameter of the substrate. The upper face of the substrate holder contains a pocket, wherein a groove is formed to act as a “thermal choke” to improve uniformity of temperature within the portion of the substrate holder directly below the substrate.

U.S. Pat. Nos. 5,633,073 and 5,688,331 disclose ceramic substrate holders with embedded metal electrodes.

U.S. Pat. No. 5,683,606 discloses a ceramic heater that includes a substrate made of aluminum nitride, a resistive heating element buried in the substrate and terminals electrically connected to the resistive heating element and buried in the substrate.

U.S. Pat. Nos. 5,231,690 and 5,490,228 disclose a heater for use in semiconductor processing that includes a discoidal substrate made of a dense ceramic and a resistance heating element in the discoidal substrate.

It is essential to provide good distribution of heat (i.e., an even temperature distribution) in the substrate holder so that the thickness of film deposited on the substrate is uniform. None of the heater assemblies to date have been able to effectively accomodate the sensitivity to temperature differences for process runs.

In light of the above, improved methods, systems and apparatus are needed for efficient deposition of films in a highly temperature differential sensitive, high temperature (at least about 400° C.) environment. Optimally, these improved methods and apparatus will result in improved substrate thickness uniformity and improved substrate electrical properties.

### SUMMARY OF THE INVENTION

The present invention provides a substrate holder/heating device for use in a semiconductor fabricating apparatus.

The present invention involves the use of a thermal heat pipe made from Graphfoil embedded in AIN in a substrate holder/heater. The thermal heat pipe provides improved controllability for even temperature distribution on the substrate holder, and thus enhances heating efficiency.

The substrate holder/heater of the invention, distributes heat evenly within itself, thereby providing uniform heat distribution to the substrate. The substrate holder/heater of the invention permits a high level of control of substrate temperature during fabrication.

The substrate holder/heater of the invention permits <1° C. temperature difference (e.g., about 0.7° C.) from the center to the edge of the substrate in the substrate holder/heater. This is to be contrasted to heaters in the art, wherein typically a 5° C. difference in temperature is observed. The substrate holder/heating device of the invention may be applied to any semiconductor manufacturing device similar to the CVD, PVD and PECVD apparatus.

The high level of temperature control permits production of substrates having superior electrical properties. For example, the minimal temperature variation permits minimal change in the critical thickness of the resulting substrate.

In accordance with another embodiment, the present invention provides a substrate holder/heater assembly suitable for use in an environment of corrosive plasma species and in the presence of a plasma at temperatures above about 400° C.

### BRIEF DESCRIPTION OF THE DRAWINGS

FIG. 1 is a schematic diagram of a deposition system in which the substrate holder of the invention may be used.

FIG. 2 is a schematic cross-sectional side view of an arm supporting the substrate holder of the invention.

FIG. 3 is a schematic cross-sectional view of a substrate holder/heater with embedded heat pipe of the invention.

### DETAILED DESCRIPTION OF THE INVENTION

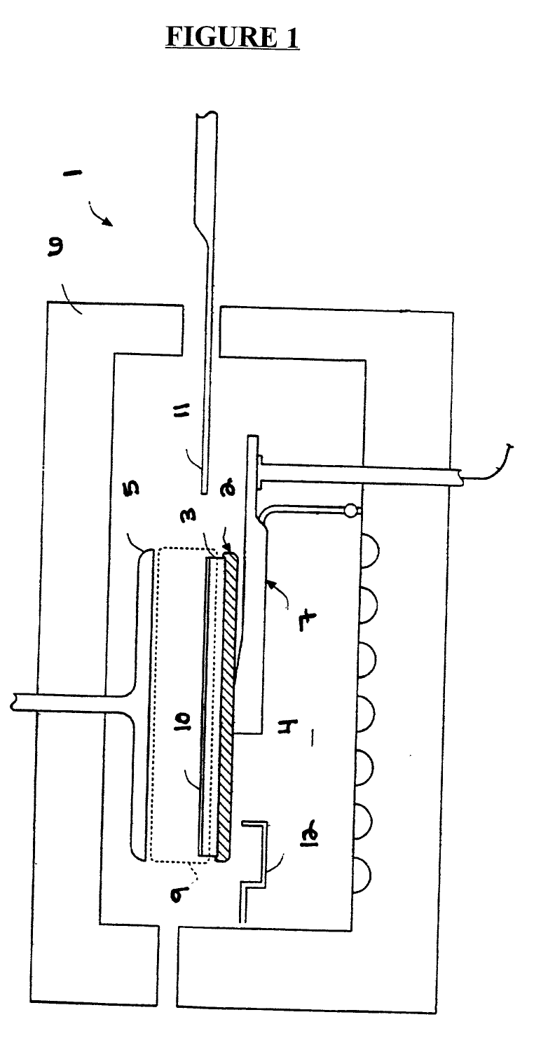

As shown in FIG. 1, a typical deposition system [1] includes a substrate holder [2] which supports a substrate [3] in a vacuum sealed chamber [4]. A perforated gas distribution plate [5] (sometimes called a “shower head”) is suspended from an upper casing [6] about one inch above substrate [3]. A robot arm [7] raises or lowers substrate holder [2] in chamber [4].

The substrate [3] may be a semiconductor wafer, such as silicon or gallium arsenide; a glass plate; a plastic workpiece; or any other such object to be processed in the chamber. The processing may be any type of vapor deposition, including dielectric deposition (e.g., silicon oxide or silicon nitride) and metal deposition (e.g., tungsten). Generally, the invention applies to any deposition process utilizing a substrate holder which will be cleaned by, e.g., fluorine. The description herein assumes that the substrate is a silicon wafer approximately six to eight inches in diameter which will be subject to PECVD processing.

Substrate holder [2] performs three functions. First, substrate holder [2] supports substrate [3] in the center of chamber [4]. Second, for a PECVD process, substrate holder [2] acts as an electrode, such as a negative RF electrode. For other vapor deposition processes, the substrate holder [2] might act as a different type of electrode. Third, substrate holder [2] transfers energy from heating element [8] to substrate [3] to heat the substrate.

In a deposition process to coat substrate [3], the chamber [4] is heated to a temperature of about 400° C. to 600° C. and is maintained at a pressure of about five to ten mtorr. Substrate holder [2] is driven as a negative RF electrode, and either a gas distribution plate (not shown) or an upper casing [6] is driven as a positive RF electrode to apply an electromagnetic field across the substrate [3]. Deposition gases, such as silane and nitrogen, are injected into chamber [4] through the gas distribution plate [5]. A plasma is formed in region [9], and a chemical reaction occurs inside the chamber to deposit a thin film layer [10], such as silicon nitride, onto substrate [3].

A blade [11] attached to robot arm [7] carries substrate [3] into and out of chamber [4]. Four lift pins [12] (only one pin is shown in FIG. 1) fit through lift pin holes in substrate holder [2]. Blade [11] carries substrate [3] above the substrate holder [2], the lift pins project up through the lift pin holes to lift substrate [3] off of blade [11], blade [11] retracts, and the lift pins lower substrate [3] into position on substrate holder [2]. Substrate [3] is removed from chamber [4] by the reverse process, beginning with the lift pins raising substrate [3] off of substrate holder [2].

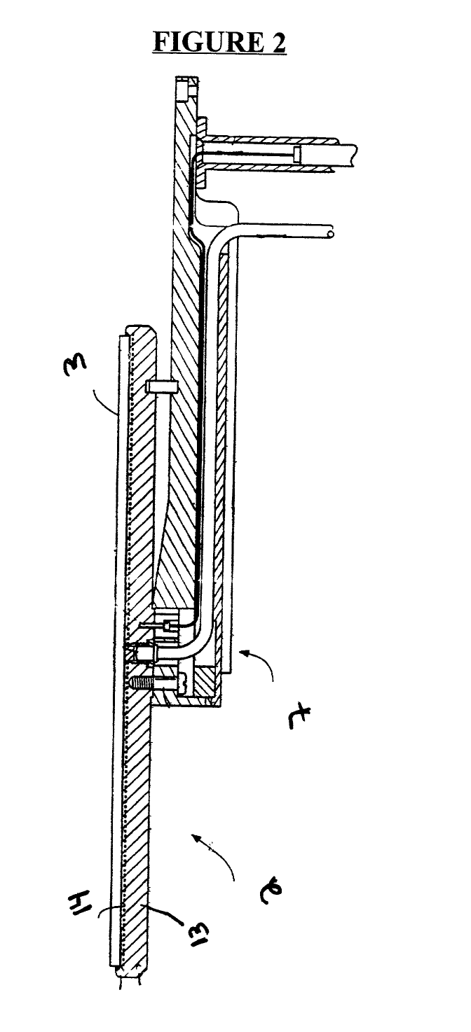

Substrate holder [2] and arm [7] are shown in more detail in FIG. 2. Substrate holder [2] is a ceramic member [13] with an embedded conductive metallic layer [14] which serves as the negative RF electrode. By completely embedding metallic layer [14] in ceramic member [13], the corrosive external environment cannot reach the electrode. The conductive metallic layer [14] has a large number of apertures, and the ceramic member contains at least two inner plates [15, 16] made of Graphfoil (i.e., layers of graphite pressed together) and an outer ceramic layer of, e.g., aluminum nitride, approximately 99.5% pure. One disk [15] is located above the heating element and a second disk [16] is located below the heating element. Disks [15, 16] guide heat generated by the heating element between them. Preferably, metallic layer [14] is a high melting-point metal (e.g., above 1700° C.) such as molybdenum, tantalum, platinum, or tungsten, or a combination thereof.

Graphfoil, which is made by pressing layers of graphite together, is a material having high thermal conductivity in a radial direction and low thermal conductivity in a transverse direction. For example, the radial thermal conductivity of Graphfoil is about 221 and the transverse thermal conductivity is about 7. This is due to the ready propagation of heat within each individual sheet and the inadequate propagation of heat from one sheet to another. Consequently, heat is conducted evenly radially and withheld transversely. Hot spots therefore do not propagate heat through the thickness of the Graphfoil and do not effect the distribution of heat to the substrate holder.

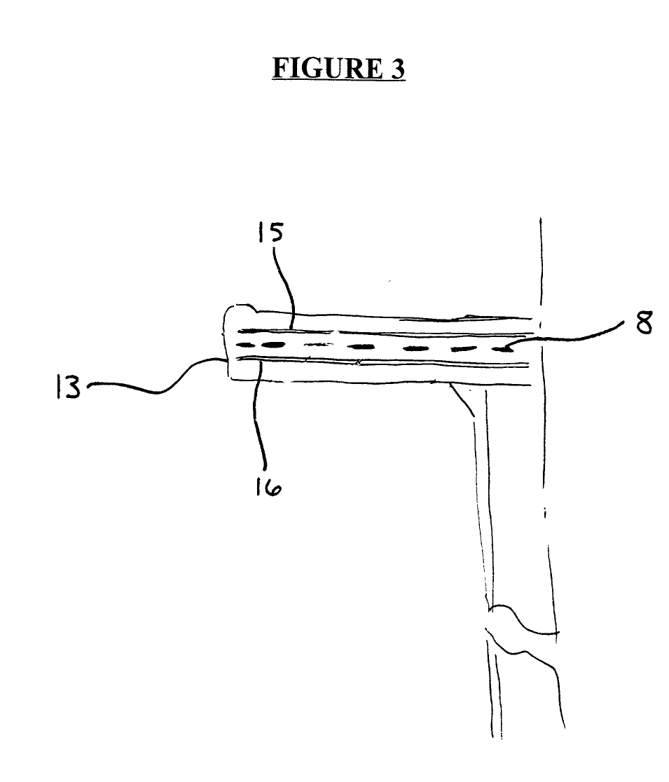

FIG. 3 is a schematic of a substrate holder/heater with embedded heat pipe of the invention. A high thermal conductivity heat pipe made with Graphfoil is embedded in an AlN substrate holder/heater. Graphfoil is a preferred graphite material due to the high, i.e., ˜100:1 ratio, of thermal conductivity.

In accordance with a specific embodiment, the substrate holder/heater of the invention may provide a lower thermal mass, i.e., it does not store heat energy for an extended period of time, than a similar holder/heater fabricated from metal. This allows faster response time to changes in power from a temperature controller. Because it stores less heat, the inventive substrate holder/heater will cool faster, for example, when the chamber needs to be disassembled for maintenance purposes.

Exemplary processes in which the substrate holder/heater may be used use, e.g., PECVD to produce titanium films. The substrate holder/heater of the invention permits greater temperature control throughout the entire substrate surface than typically achieved with other conventional systems. An exemplary substrate processing system suitable for performing these processes is the TixZ system (equipped for 200-mm substrates or scalable to 300-mm or other sized substrates), available from Applied Materials, Inc. of Santa Clara, Calif.

An example of the use of the inventive substrate holder/heater follows:

The first step in the film deposition process is to set the temperature. During this step, the chamber is pressurized with a non-corrosive gas, such as argon, above the pressure at which deposition will occur. This may pre-charge voids or hollow spaces within the chamber with a purge gas. This purge gas will then outgas as the chamber pressure is reduced to the deposition pressure, thereby minimizing the intrusion of process gases that may corrode or oxidize parts of the substrate holder/heater or chamber. The process may be performed preferably at temperatures between about 400-750° C., most preferably about 625° C. The substrate holder/heater of the invention permits uniform distribution of temperature across the substrate surface during the process.

The substrate is loaded into the chamber. About 15 seconds after loading the substrate, the temperature is set to the operating temperature, in this instance about 625° C., as the purge gas, such as argon, is flowed into the chamber. Concurrently reducing the set-point temperature of the substrate holder/heater while initiating gas flows allows the thermal capacity of the heater to account for some of the cooling arising from the onset of the gas flow.

Suitable flow rates of the purge gas range between about 500-3000 sccm, preferably about 1000 sccm, for a chamber with a volume of about 5.5 liters. During this time, the substrate is held about 550 mil from the showerhead, and the chamber is pumped down to about 4.5 torr. It is understood that greater or lesser flow rates would be appropriate for larger or smaller chambers. A plasma gas, such as argon, is concurrently admitted into the chamber via the showerhead at a flow rate between about 1000-10000 sccm, preferably about 5000 sccm. The plasma gas is easily formed into a plasma with an appropriate application of RF energy. The mixture of the plasma gas with the reactant and source gases facilitates forming a plasma from the reactant and source gases. Simultaneously, a reactant gas, such as hydrogen (H₂), is turned on at an initial flow rate. The reactant gas lowers the energy required for the decomposition of the source gas to form the desired film and also reduces the corrosivity of the deposition byproducts by converting some of the chlorine to hydrogen chloride (HCl), rather than leaving it as Cl^{—} or Cl₂.

Next, the reactant gas is set to its final processing flow rate of about 9500 sccm, which is held for about five seconds before the substrate is moved to its processing position, approximately 400 mil from the showerhead nozzle. This condition is held for an additional five seconds to allow the gas flow pattern to stabilize, and then the RF power is turned on. The RF frequency may be between about 300-450 kHz, preferably about 400 kHz, at a power level between about 200-2000 watts, preferably about 700 watts. These conditions, including use of argon, establish a stable plasma without needing additional means to ignite a glow discharge, such as an ultra-violet source or a spark generator. A titanium film will be deposited on the substrate at a rate of about 200 Å/min. Accordingly, holding these process conditions for about 100 seconds will result in a titanium film approximately 300 Å thick. After the desired film has been deposited, the source and reactant gases are turned off.

What is claimed is:

1. A substrate holder/heater assembly suitable for use in semiconductor substrate fabrication reaction chamber, said substrate holder/heater assembly comprising:
a heater element;
a thermal plate facing said heater element, said plate comprising multiple layers of graphite foil pressed together; and
a ceramic body, said ceramic body having a top surface for supporting a substrate and a bottom surface; wherein said heater element and said thermal plate are disposed in said ceramic body.

2. The substrate holder/heater assembly of claim 1, further including a second thermal plate facing a side of said heater element opposite of said thermal plate.

3. The substrate holder/heater assembly of claim 1, wherein said ceramic body is comprised of aluminum nitride.

4. The substrate holder/heater assembly of claim 1, further comprising an RF electrode comprised of molybdenum.

5. The substrate holder/heater assembly of claim 1, wherein said thermal plate extends at least to the periphery of said heater element.
